(19) United States
(12) Patent Application Publication
(10) Pub. No.: US 2018/0266375 A1
(43) Pub. Date: Sep. 20, 2018

(54) CLIP FOR FUEL INJECTION VALVE AND FUEL INJECTION VALVE UNIT

(71) Applicant: DENSO CORPORATION, Kariya-city, Aichi-pref. (JP)

(72) Inventor: Hiromu SUZUKI, Kariya-city (JP)

(21) Appl. No.: 15/538,316

(22) PCT Filed: Dec. 15, 2015
(86) PCT No.: PCT/JP2015/006252

§ 371 Date: Jun. 21, 2017

(30) Foreign Application Priority Data
Dec. 24, 2014 (JP) 2014-260615

(51) Int. Cl. F02M 61/14

(52) U.S. Cl. CPC F02M 61/14; F02M 2200/853

(57) ABSTRACT

A clip for a fuel injection valve is formed by one wire member bent at a plurality of parts, and includes a contact part that contacts with a contacted surface formed on a fuel injection valve; a pressed part pressed in a downward direction by a pressing surface formed on a fuel supply pipe; a spring part formed between one end of the contact part and the pressed part and deformed by load in the downward direction received by the pressed part and transmitting the load in the downward direction to the contact part; and a rotation stopping part extended in an upward direction from an end part of the contact part opposite to the spring part and fitting with a rotation stopping fitting part of the fuel supply pipe. Since the spring part, the pressed part, and the rotation stopping part are connected to the respective end parts of the contact part opposite to each other, a stress is hardly transmitted to the rotation stopping part when the pressed part is pressed.

### CROSS REFERENCE TO RELATED APPLICATIONS

This application is based on Japanese Patent Application No. 2014-260615 filed on Dec. 24, 2014, the disclosure of which is incorporated herein by reference.

### TECHNICAL FIELD

The present disclosure relates to a clip for a fuel injection valve mounted to the fuel injection valve in a fuel injection device, and a fuel injection valve unit including the fuel injection valve and the clip for a fuel injection valve.

### BACKGROUND ART

In a fuel injection device which injects fuel to an internal combustion engine, a support clamp which holds a fuel injection valve mounted to the internal combustion engine by pressing the fuel injection valve has been known. For example, the support clamp disclosed in Patent Literature 1 is formed by punching a plate member by a press and by bending the punched member into a predetermined shape.

However, since the support clamp disclosed in Patent Literature 1 is formed by using the plate member, production yield is deteriorated, and further since the shape of the support clamp is complicated, a cost in processing and manufacturing might be increased. In order to solve the problems, a support clamp integrally formed by a wire member is disclosed in Non Patent Literature 1.

Hereinafter, a same kind of member as the support clamp disclosed in Non Patent Literature 1 is referred to as “a clip for a fuel injection valve”. Further, “rotation stop part” and “engagement part” in the clip for a fuel injection valve disclosed in Non Patent Literature 1 are respectively called “rotation stopping part” and “contact part”.

In the clip for a fuel injection valve in Non Patent Literature 1, the rotation stopping part is connected to one end of the contact part via a spring part, and a connection part is connected to the other end of the contact part. Thus, when a part (pressed part) contacted with a connection cup is pressed, the spring part is elastically deformed and at the same time the rotation stopping part is displaced, and therefore the rotation stopping part might be dropped off from a rotation stopping fitting part of a fuel supply pipe.

### PRIOR ART LITERATURES

### Patent Literature

Patent Literature 1: JP 5126083 B2

### Non Patent Literature

Non Patent Literature 1: Japan Institute for Promoting Invention and Innovation Journal of Technical Disclosure No. 2014-500735

### SUMMARY OF INVENTION

It is an object of the present disclosure to provide a clip for a fuel injection valve which prevents a rotation stopping part from dropping off from a rotation stopping fitting part of a fuel supply pipe when a pressed part is pressed. Further, it is another object of the present disclosure to provide a fuel injection valve unit including the clip for a fuel injection valve and the fuel injection valve.

The present disclosure relates to, in a fuel injection device having a fuel supply pipe; and a fuel injection valve connected to the fuel supply pipe and capable of injecting fuel supplied from the fuel supply pipe to an internal combustion engine from an injection port formed at its distal end, the clip for a fuel injection valve which is fitted with the rotation stopping fitting part formed on the fuel supply pipe and mounted to at least a part of an outer peripheral of the fuel injection valve, the clip for a fuel injection valve holding the fuel injection valve between the fuel supply pipe and the internal combustion engine.

The clip for a fuel injection valve is formed by one wire member bent at multiple points.

Here, terminologies used in the following description are defined.

At first, an axis of the fuel injection valve is defined as a virtual axial line. A direction parallel to the virtual axial line is defined as a z-direction, and a direction toward the fuel supply pipe in the z-direction is defined as a plus z-direction, and a direction toward a distal end of the fuel injection valve in the z-direction is defined as a minus z-direction. Further, a direction orthogonal to the z-direction and connecting the virtual axial line and a side where the rotation stopping fitting part is formed is defined as a y-direction, and a direction orthogonal to both of the z-direction and the y-direction is defined as an x-direction.

The clip for a fuel injection valve according to the present disclosure is provided with at least one contact part, at least one pressed part, at least one elastic part, and at least one rotation stopping part.

The contact part contacts with a contacted part formed on the fuel injection valve.

The pressed part is located on the plus z-direction side with respect to the contact part and is pressed in the minus z-direction by a pressing surface formed on the fuel supply pipe.

The elastic part is formed between one end of the contact part in the y-direction and the pressed part. The elastic part is elastically deformed by a load in the minus z-direction received by the pressed part and transmits the load in the minus z-direction to the contact part.

The rotation stopping part is extended in the plus z-direction from an end part of the contact part opposite to a spring part and is fitted with the rotation stopping fitting part. With this, the rotation stopping part can prevent relative rotation between the fuel supply pipe and the fuel injection valve.

In the clip for a fuel injection valve according to the present disclosure, the spring part and the pressed part are connected to one end of the contact part, and the rotation stopping part is connected to the other end of the contact part. Namely, the spring part and the pressed part, and the rotation stopping part are connected to mutually opposite end parts of the contact part. Accordingly, even if the pressed part is pressed by the pressing surface and the spring part is deformed, its stress is hardly transmitted to the rotation stopping part. Thus, the rotation stopping part can be prevented from dropping off from the rotation stopping fitting part of the fuel supply pipe.

### BRIEF DESCRIPTION OF DRAWINGS

The above and other objects, features, and advantages of the present disclosure will become more apparent from the following detailed description made with reference to the accompanying drawings.

FIG. 1A is a perspective view of a clip for a fuel injection valve according to a first embodiment of the present disclosure when seen from a front surface side.

FIG. 1B is a perspective view of the clip for a fuel injection valve according to the first embodiment of the present disclosure when seen from a back surface side.

FIG. 2 is a front view of the clip for a fuel injection valve shown in FIG. 1A and

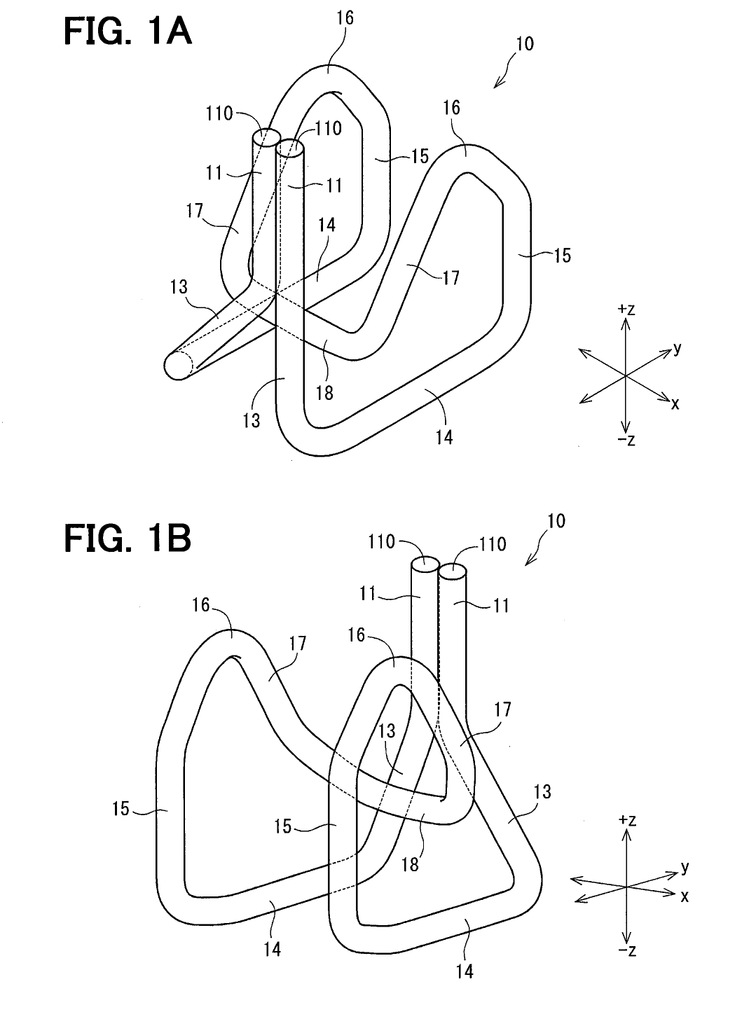

FIG. 1B.

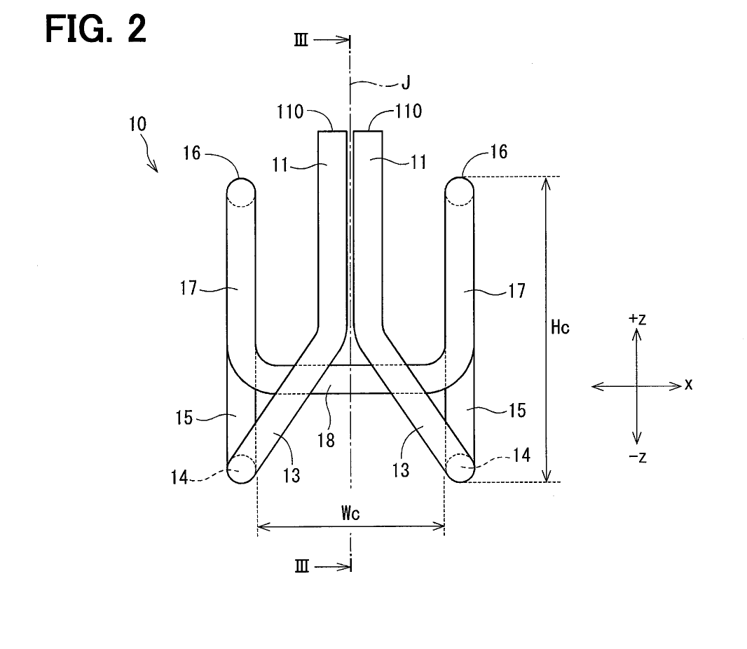

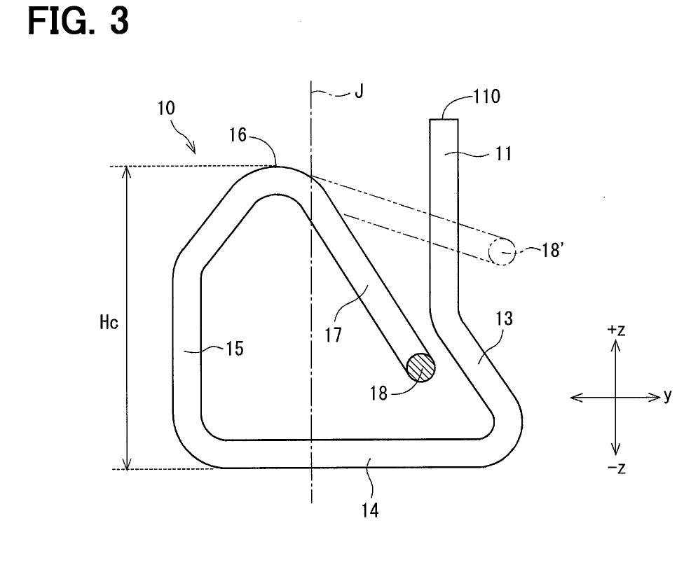

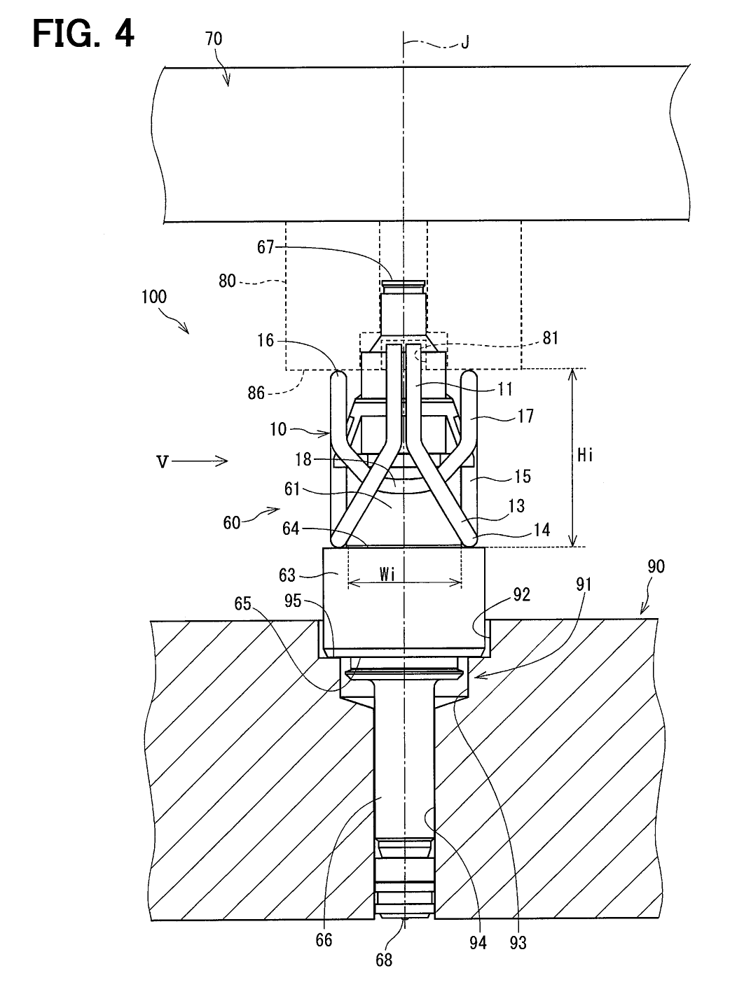

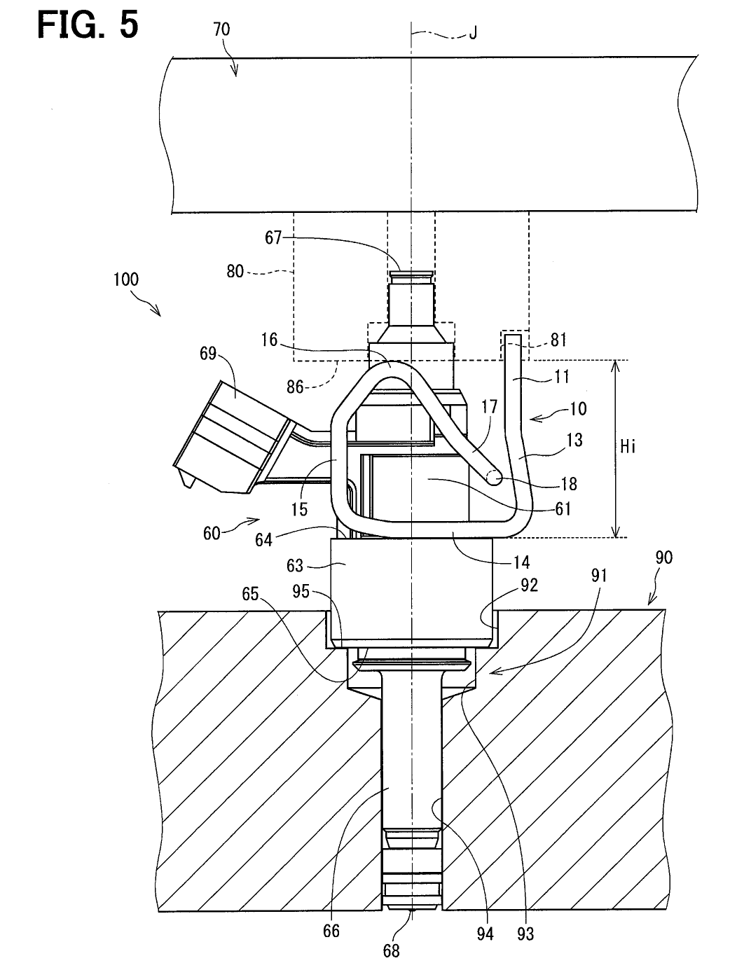

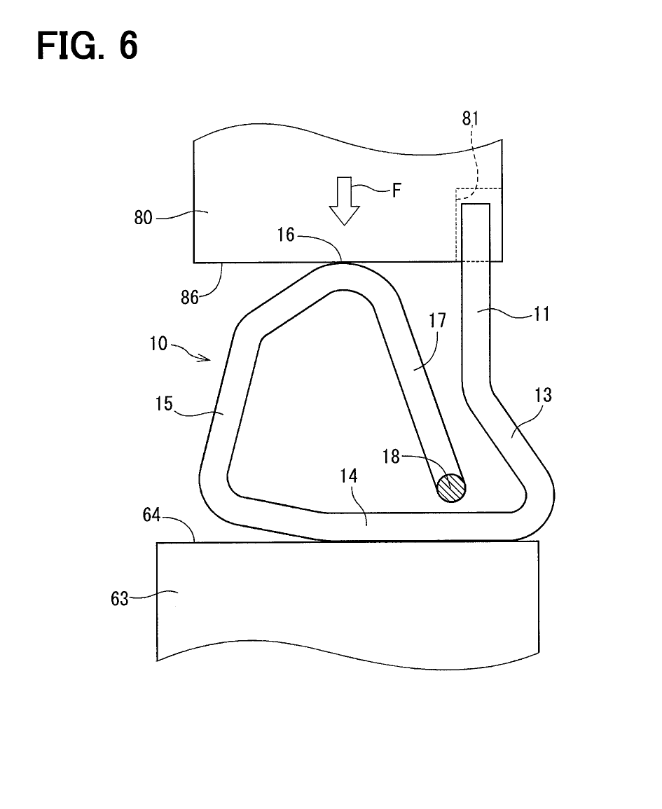

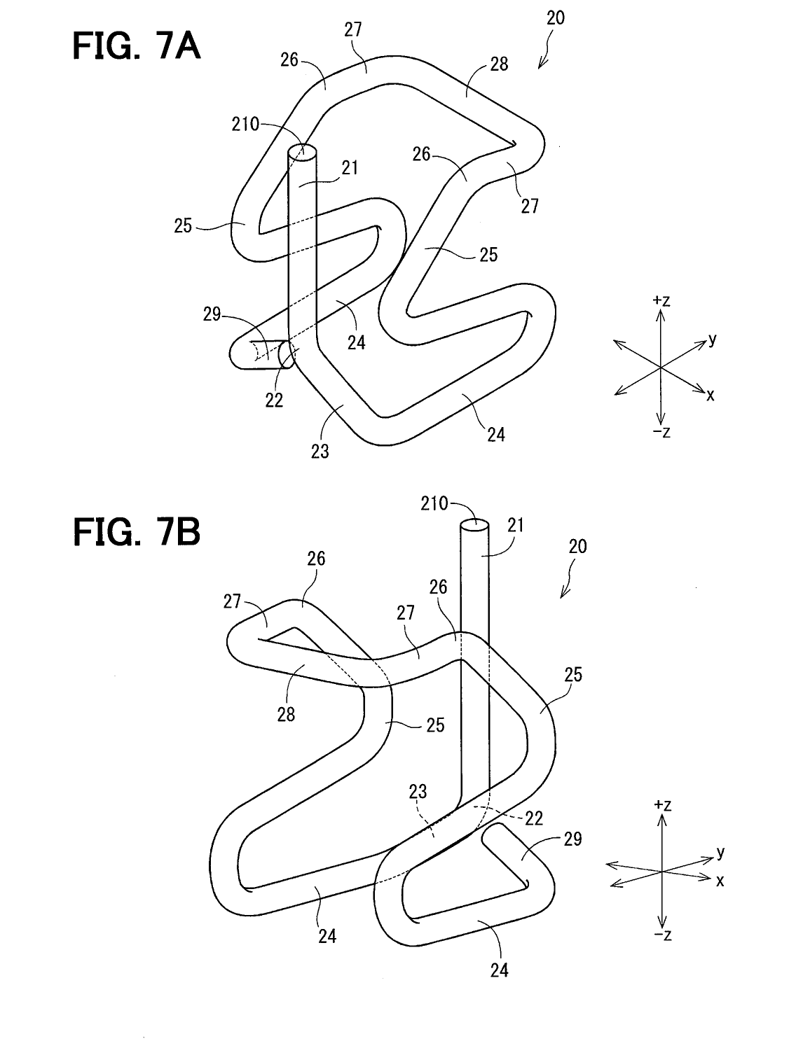

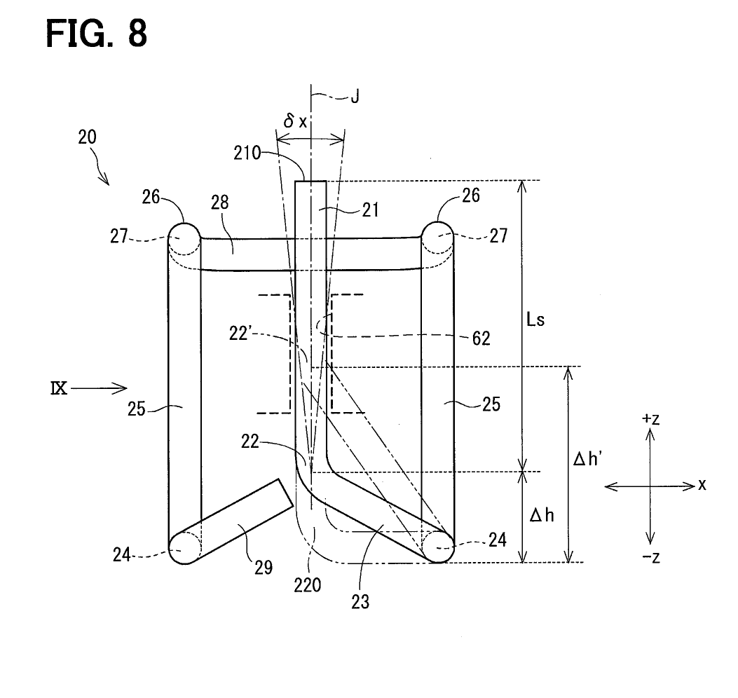

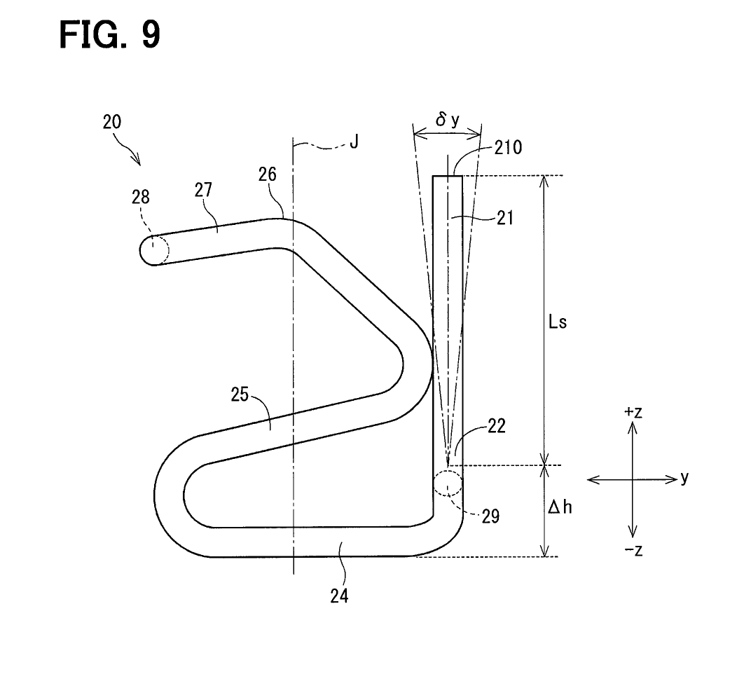

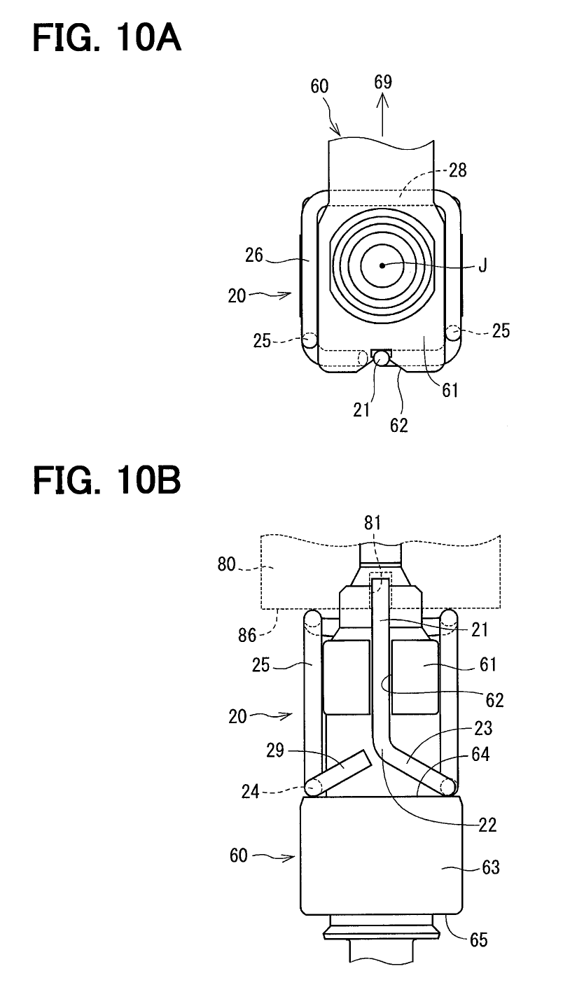

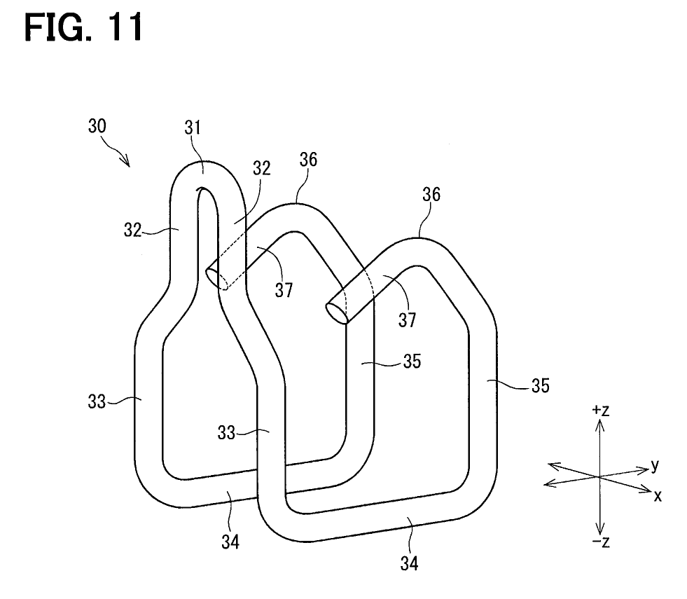

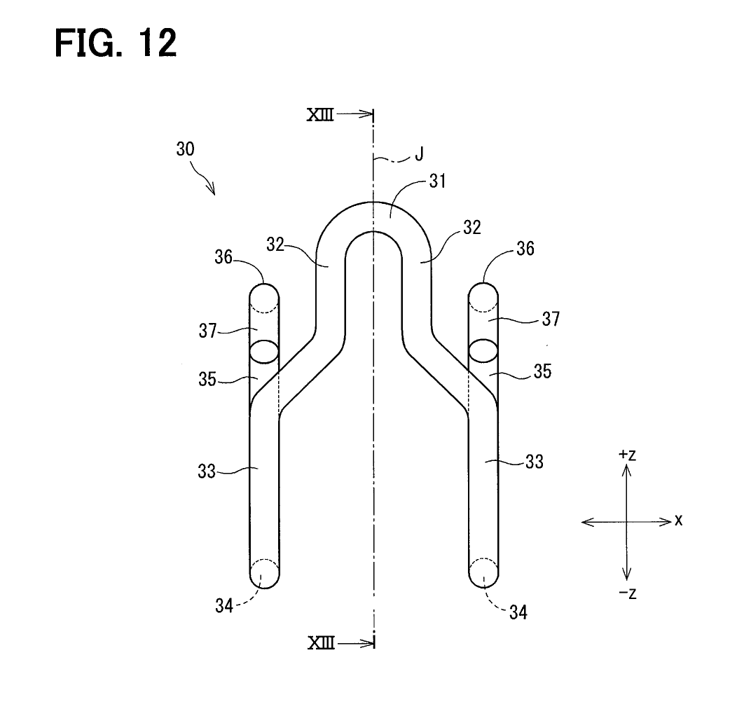

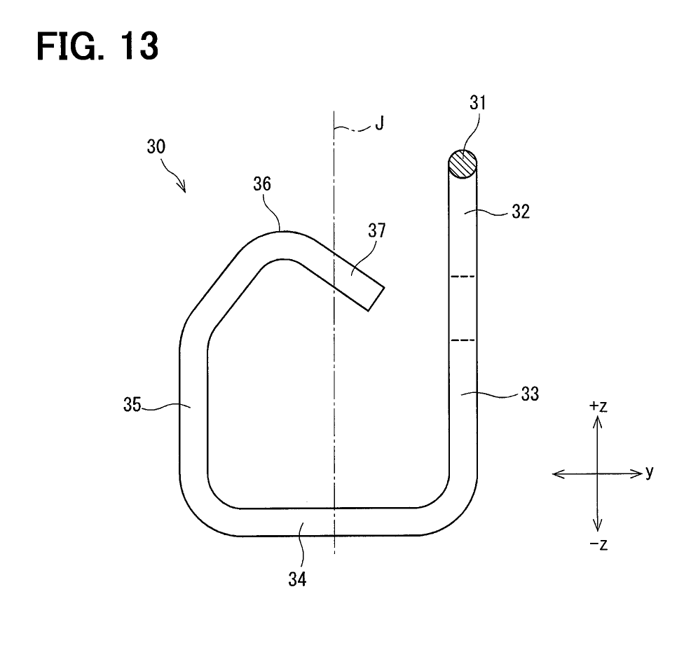

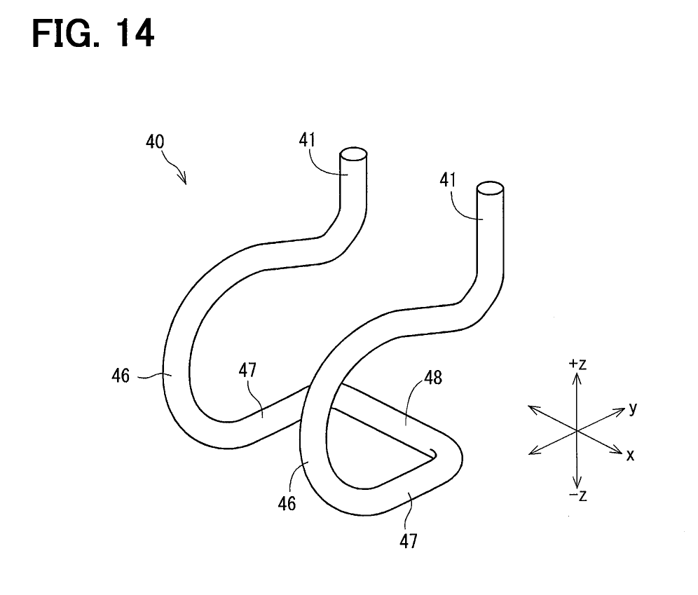

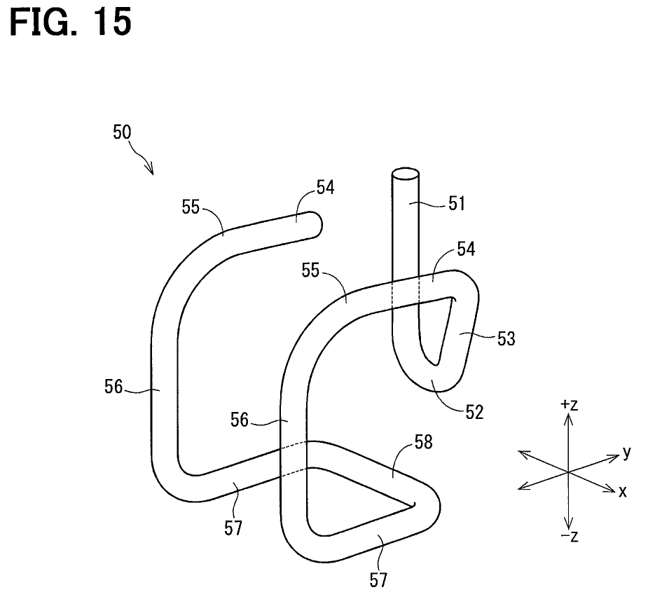

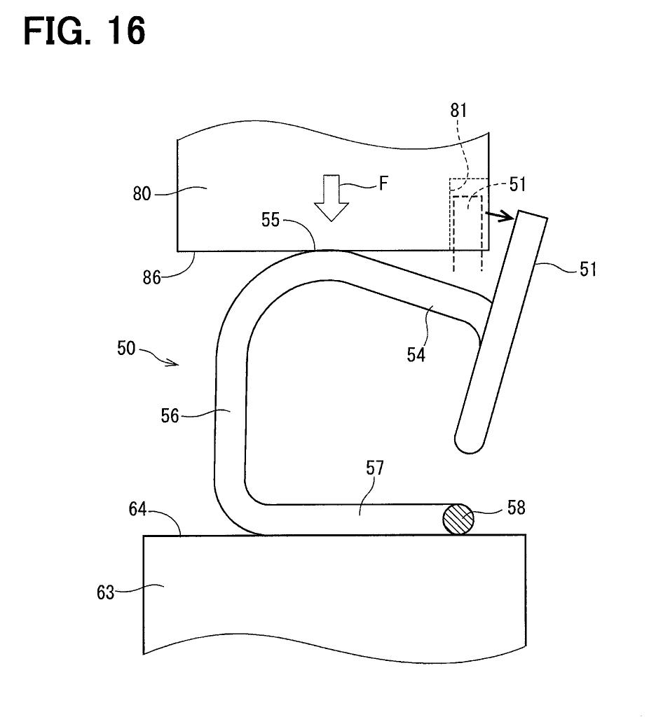

FIG. 3 is a cross-sectional view taken along a line III-Ill in FIG. 2.

FIG. 4 is a diagram illustrating a state where the fuel injection valve to which the clip for a fuel injection valve according to the first embodiment of the present disclosure is mounted is mounted to an engine.

FIG. 5 is a side view seen along V-direction indicated by an arrow in FIG. 4.

FIG. 6 is a diagram illustrating a state where a pressed part of the clip for a fuel injection valve shown in FIG. 1A and FIG. 1B is pressed.

FIG. 7A is a perspective view of a clip for a fuel injection valve according to a second embodiment of the present disclosure when seen from a front surface side.

FIG. 7B is a perspective view of the clip for a fuel injection valve according to the second embodiment of the present disclosure when seen from a back surface side.

FIG. 8 is a front view of the clip for a fuel injection valve shown in FIG. 7A and FIG. 7B.

FIG. 9 is a side view seen along a IX-direction indicated by an arrow in FIG. 8.

FIG. 10A is a diagram illustrating a state where a rotation stopping part of the clip for a fuel injection valve shown in FIG. 7A and FIG. 7B is fitted into a support groove of the fuel injection valve.

FIG. 10B is a diagram illustrating a state where the rotation stopping part of the clip for a fuel injection valve shown in FIG. 7A and FIG. 7B is fitted into the support groove of the fuel injection valve.

FIG. 11 is a perspective view of a clip for a fuel injection valve according to a third embodiment of the present disclosure when seen from a front surface side.

FIG. 12 is a front view of the clip for a fuel injection valve shown in FIG. 11.

FIG. 13 is a cross-sectional view taken along a line XIII-XIII in FIG. 12.

FIG. 14 is a perspective view of a clip for a fuel injection valve according to a first comparative example when seen from a back surface side.

FIG. 15 is a perspective view of a clip for a fuel injection valve according to a second comparative example when seen from a back surface side.

FIG. 16 is a diagram illustrating a state where a pressed part of the clip for a fuel injection valve according to the second comparative example is pressed.

### EMBODIMENTS FOR CARRYING OUT INVENTION

Hereinafter, a clip for a fuel injection valve according to each embodiment of the present disclosure is described with reference to drawings.

### First Embodiment

A clip for a fuel injection valve according to a first embodiment is described with reference to FIG. 1A to FIG. 6. At first, a whole configuration of a fuel injection device 100 to which the clip for a fuel injection valve is applied is described with reference to FIG. 4 and FIG. 5.

The fuel injection device 100 includes a rail body 70, a connecting pipe 80, a fuel injection valve 60, and the like. The rail body 70 and the connecting pipe 80 form “fuel supply pipe”. The block-like rail body 70 distributes high pressure fuel supplied from a high pressure pump not shown into a plurality of passages in accordance with a number of cylinders of an internal combustion engine 90 (hereinafter, referred to as “engine”). FIG. 4 and FIG. 5 show only one passage among them. The connecting pipe 80 is arranged so as to protrude toward the engine 90 from a bottom surface of the rail body 70. The connecting pipe 80 is also called “connecting cup”.

The fuel injection valve 60 is mounted between (i) the rail body 70 and the connecting pipe 80, and (ii) the engine 90. Specifically, a side of a fuel inlet 67 is connected to the connecting pipe 80, and a distal end side having an injection port 68 is inserted into a mount hole 91 of the engine 90. The mount hole 91 includes a receiving hole part 92, an escape hole part 93, and a fitting hole part 94. A lower end surface 65 of a large diameter part 63 of the fuel injection valve 60 is contacted with a bottom surface 95 of the receiving hole part 92, and a cylindrical part 66 is fitted with the fitting hole part 94.

The fuel injection valve 60 is opened and closed in accordance with a signal input to a connector 69 from an external controller. The fuel injection valve 60 can inject fuel, which is supplied from the rail body 70 via the connecting pipe 80, to the engine 90 from the injection port 68 formed at the distal end of the cylindrical part 66.

The clip 10 for a fuel injection valve is mounted to at least a part of an outer periphery of a body part 61 of the fuel injection valve 60. Hereinafter, the clip 10 for a fuel injection valve is referred to as merely “clip 10”. Further, a combination of the clip 10 and the fuel injection valve 60 to which the clip 10 is mounted is called “fuel injection valve unit”.

The clip 10 is interposed between a pressing surface 86 which is a lower end surface of the connecting pipe 80 and a contacted surface 64 which is an upper end surface of the large diameter part 63 of the fuel injection valve 60 in a state where the clip 10 is mounted to the fuel injection valve 60. With this, the clip 10 holds the fuel injection valve 60 between (i) the rail body 70 and the connecting pipe 80, and (ii) the engine 90.

The clip 10 has a characteristic configuration especially in a shape against the conventional art. Hereinafter, an axis J of the fuel injection valve 60 shown in FIG. 4 and FIG. 5 is a reference of positions and directions when the shape of the clip 10 is described in detail. Thus, the axis J of the fuel injection valve 60 to which the clip 10 is mounted is defined as “virtual axial line J”, and it is used to specify the clip 10 regardless of existence of the fuel injection valve 60.

Further, three directions with respect to the virtual axial line J are defined as described below. At first, a direction parallel to the virtual axial line J is defined as a z-direction. A direction toward the connecting pipe 80 in the z-direction is defined as a plus z-direction, and a direction toward a distal end of the fuel injection valve 60 in the z-direction is defined as a minus z-direction. In other words, an upward direction in FIG. 4 and FIG. 5 is the plus z-direction, and a downward direction is the minus z-direction.

Further, a rotation stopping fitting part 81 is formed at a specific part in a circumferential direction on the connecting pipe 80. Thus, a direction orthogonal to the z-direction and connecting the virtual axial line J and a side where the rotation stopping fitting part 81 is formed is defined as a y-direction, and a direction orthogonal to both of the z-direction and y-direction is defined as an x-direction. A lateral direction in FIG. 4 is the x-direction, and a lateral direction in FIG. 5 is the y-direction.

Here, the y-direction is defined by “a direction connecting the virtual axial line J and a side where the rotation stopping fitting part 81 is formed” instead of “a direction connecting the virtual axial line J and the rotation stopping fitting part 81”. This is because the rotation stopping fitting part 81 is not always formed at one point but may be formed in a range having a certain area. In a case where the rotation stopping fitting part 81 is formed in the certain area, the y-direction is defined by a direction connecting the virtual axial line J and an arbitrary point at the side where the rotation stopping fitting part 81 is formed.

Next, a detailed configuration of the clip 10 is described with reference to FIG. 1A to FIG. 3. Hereinafter, in the y-direction, a side where a rotation stopping part 11, which fits with the rotation stopping fitting part 81, is formed is defined as “a front surface”, and a side opposite to the front surface is defined as “a back surface”. FIG. 1A is a perspective view seen from a front surface side, and FIG. 1B is a perspective view seen from a back surface side. Further, FIG. 2 is a front view, and FIG. 3 is a cross-sectional view seen in a side direction. Similar drawings are used in embodiments described below.

Further, in the drawings, the plus z-direction is shown as “+z” and the minus z-direction is shown as “−z”.

As shown in FIG. 1A to FIG. 3, the clip 10 is formed by bending one wire member at a plurality of parts. The wire member has spring elasticity, and is formed of metal such as stainless. Hereinafter, each part in the bent wire member is named corresponding to its function. Especially, the clip 10 according to the first embodiment is formed symmetric with respect to x-direction to have a symmetry plane in yz-plane which passes the virtual axial line J. Accordingly, each part is formed in a pair, namely each part is formed of two components except a connection part 18 crossing the symmetry plane.

In the wire member, an escape part 13, a contact part 14, a spring part 15, a pressed part 16, an extension part 17, and the connection part 18 are connected in order from a rotation stopping part 11 at one side. Further, the extension part 17 at an opposite side is connected via the connection part 18, and the extension part 17 to the rotation stopping part 11 at the opposite side are connected in order opposite to the above-described order.

At first, the contact part 14, the spring part 15, and the pressed part 16 are described.

A position of the contact part 14 in the z-direction is constant, and the contact part 14 is linearly extended in the y-direction. Accordingly, when the clip 10 is put on a horizontal plane with the contact part 14 located at a low side, the z-direction as a direction of the virtual axial line J is matched with a vertical direction, and the x-direction and the y-direction are matched with horizontal directions.

In the following description, this position is defined as a reference position of the clip 10, and therefore “plus z-direction” is described as “upward direction” and “minus z-direction” is described as “downward direction” as needed.

The pressed part 16 is located right above an intermediate part of the contact part 14 at an apex point of a mountain-like shape, namely at a maximum point. In a case where a section of the wire member is a circular shape, one point on a circumference which contacts with the pressing surface 86 corresponds to the pressed part 16 in the strict sense. However, when the pressed part 16 is pressed in a free state, the contact point may be slightly shifted. Further, the contact point is changed due to variation in dimension of the part, thus practically, a certain range including the contact point with the pressing surface 86 is defined as “pressed part 16”. It can be also considered that the pressed part 16 is located at the highest point except the rotation stopping part 11 in the clip 10.

The spring part 15 is formed from one end of the contact part 14 in the upward direction so as to connect the contact part 14 and the pressed part 16. The spring part 15 is elastically deformed by a part of load in the downward direction received by the pressed part 16, and the spring part 15 transmits the load in the downward direction to the contact part 14. Precisely, the load which is remained after consuming to elastically deform the spring part 15 is transmitted to the contact part 14.

As shown in FIG. 4 and FIG. 5, in a state where the clip 10 is mounted to the fuel injection valve 60, the contact part 14 is contacted with a contacted surface 64 which is the upper end surface of the large diameter part 63 of the fuel injection valve 60. The pressed part 16 is contacted with the pressing surface 86 which is the lower end surface of the connecting pipe 80. In this way, the clip 10 is interposed between the contacted surface 64 in the plus z-direction and the pressing surface 86 in the minus z-direction.

A free height “Hc” (see FIG. 2 and FIG. 3) between the contact part 14 and the pressed part 16 of the clip 10 is set to be larger than a gap “Hi” between the contacted surface 64 and the pressing surface 86, and therefore when the clip 10 is mounted, the pressed part 16 is pressed in the minus z-direction by the pressing surface 86. With this, the contacted surface 64 is pressed by the contact part 14, and the lower end surface 65 of the large diameter part 63 is pressed against a bottom surface 95 of the receiving hole part 92. As a result, the fuel injection valve 60 is held by the mount hole 91 of the engine 90 without any backlash.

Since the pressed part 16 is pressed by the pressing surface 86 in such a way, it is preferable that the pressed part 16 is located at a part relatively adjacent to the virtual axial line J in the y-direction in view of balance of weight.

Further, the contact parts 14 are formed at one side and the other side in the x-direction with respect to the virtual axial line J respectively, namely two contact parts 14 are formed. A gap “Wc” (see FIG. 2) between the two contact parts 14 is set to be similar to a width “Wi” (see FIG. 4) of the body part 61 of the fuel injection valve 60, and therefore the fuel injection valve 60 is interposed between the two contact parts 14.

Next, the rotation stopping part 11 is extended in the upward direction from an end part of the contact part 14 opposite to the spring part 15, and the rotation stopping part 11 is fitted with the rotation stopping fitting part 81 of the connecting pipe 80. In the first embodiment, the two rotation stopping parts 11 are fitted with the rotation stopping fitting part 81 in a state where the two rotation stopping parts 11 are adjacent to each other.

When the rotation stopping part 11 is fitted with the rotation stopping fitting part 81, positions of the connecting pipe 80 and the clip 10 are fixed in a rotational direction. Further, when the fuel injection valve 60 is interposed between the contact parts 14 of the clip 10, the fuel injection valve 60 is prevented from relatively rotating against the connecting pipe 80 by the clip 10.

Next, the two extension parts 17 are respectively extended from the two pressed parts 16. The connection part 18 connects end parts of the two extension parts 17 with each other in the x-direction. Namely, the connection part 18 connects the two pressed parts 16 in the x-direction via the two extension parts 17.

In the first embodiment, the connection part 18 is closer to the rotation stopping part 11 than to the pressed part 16 in the y-direction and closer to the contact part 14 in the z-direction. Accordingly, the extension part 17 is extended from the pressed part 16 toward the rotation stopping part 11 such that it is inclined in the downward direction.

Thus, it is necessary that the connection part 18 does not interferes with the rotation stopping part 11 in a state where the clip 10 is free and the connection part 18 is displaced when the pressed part 16 is pressed.

Accordingly, in the first embodiment, the escape part 13 that avoids the interference between the connection part 18 and the rotation stopping part 11 in a range of displacement of the connection part 18 is formed between the contact part 14 and the rotation stopping part 11. Specifically, the end part of the contact part 14 opposite to the spring part 15 is extended beyond the rotation stopping part 11. The escape part 13 is extended from the part of the contact part 14 beyond the rotation stopping part 11 toward the spring part 15 in the upward direction while going back in the y-direction, and then the escape part 13 is connected to the rotation stopping part 11.

### Effects

Effects of the clip 10 according to the first embodiment are described. Since the clip 10 is formed by bending one wire member at multiple points, a manufacturing cost can be reduced compared to the support clamp disclosed in Patent Literature 1 (JP 5126083 B2) which is formed by means of press working to a plate member.

Further, the clip 10 according to the first embodiment achieves the following effects of (1) to (4) compared to the support clamp (clip) disclosed in Non Patent Literature 1 (Japan Institute for Promoting Invention and Innovation Journal of Technical Disclosure No. 2014-500735).

(1) The clip 10 is characterized in that the spring part 15 and the pressed part 16 are connected to the one end of the contact part 14 and the rotation stopping part 11 is connected to the other end of the contact part 14. The effect according to this configuration is described with reference to mainly FIG. 6 while comparing with comparative examples shown in FIG. 14 to FIG. 16.

A clip 40 according to a first comparative example shown in FIG. 14 is disclosed in Non Patent Literature 1, in which reference signs are changed from the drawings thereof. Here, in a case where a terminology in Non Patent Literature 1 is different from a terminology of a counterpart in the present description, the terminology in the present description is used to describe.

As shown in FIG. 14, in the clip 40 according to the first comparative example, a rotation stopping part 41, a spring part 46, a contact part 47, and a connection part 48 of one side are connected in this order. Namely, the rotation stopping part 41 is connected to one end of the contact part 47 via the spring part 46, and the connection part 48 is connected to the other end of the contact part 47, and this configuration is apparently different from the configuration of the clip 10 according to the first embodiment.

Since the clip 40 according to the first comparative example is largely different in a size of the spring part 46 or the like from the clip 10 according to the first embodiment, a configuration which makes it easy to compare with the configuration according to the first embodiment is shown in FIG. 15 as a second comparative example. The definition of each direction in the drawings corresponds to that in the first embodiment.

In a clip 50 according to the second comparative example, one rotation stopping part 51 is returned at a turning part 52 and connected to a pressed part 55 via a vertical connection part 53 and a horizontal connection part 54. A spring part 56 is bent substantially perpendicularly at an end of the pressed part 55 and extended in the downward direction, and a contact part 57 is bent substantially perpendicularly at an end of the spring part 56 and extended in the horizontal direction, and then the contact part 57 is connected to a connection part 58. In the clip 50 according to the second comparative example, similar to the configuration of the first comparative example, the rotation stopping part 51 is connected to one end of the contact part 57 via the spring part 56 and the pressed part 55, and the connection part 58 is connected to the other end of the contact part 57.

As shown in FIG. 16, in the clip 50 according to the second comparative example, when the pressed part 55 receives a load F from the pressing surface 86, the horizontal connection part 54 is deformed and inclined, and its moment is transmitted to the rotation stopping part 51. As a result, the rotation stopping part 51 might be dropped off from the rotation stopping fitting part 81 of the connecting pipe 80.

However, as shown in FIG. 6, in the clip 10 according to the first embodiment, the spring part 15, the pressed part 16, and the rotation stopping part 11 are connected to mutually opposite end parts of the contact part 14. Accordingly, when the pressed part 16 receives the load F from the pressing surface 86 and the spring part 15 is deformed, its stress is hardly transmitted to the rotation stopping part 11. Accordingly, the rotation stopping part 11 can be prevented from dropping off from the rotation stopping fitting part 81 of the connecting pipe 80.

(2) The two contact parts 14 are formed respectively at one side and the other side in the x-direction with respect to the virtual axial line J. By interposing the body part 61 of the fuel injection valve 60 between the two contact parts 14, a position of the clip 10 against the fuel injection valve 60 is stable. This effect is further improved by setting the gap “Wc” between the two contact parts 14 to be substantially same as the width “Wi” of the fuel injection valve.

(3) The connection part 18 connects the two pressed parts 16 with each other and thereby an end part 110 of the rotation stopping part 11 is formed by the end part of the wire member. Thus, the two rotation stopping parts 11 can be arranged without a gap therebetween or arranged adjacent to each other with a small gap. Accordingly, a width of a groove of the rotation stopping fitting part 81 with which the two rotation stopping parts 11 are fitted can be smaller.

Further, one of the two rotation stopping parts 11 may be deleted from the clip 10 according to the first embodiment. In such a case, an effect of (7) of a second embodiment described below is obtained.

(4) Since the connection part 18 is closer to the rotation stopping part 11 than to the pressed part 16 in the y-direction, a number of bent parts in the wire member can be reduced, and therefore working hours can be reduced.

Further, in this configuration, in order to avoid the interference between the connection part 18 and the rotation stopping part 11, the escape part 13 that avoids the interference between the connection part 18 and the rotation stopping part 11 in the range of the deformation of the connection part 18 is formed between the contact part 14 and the rotation stopping part 11. With this, when the pressed part 16 is pressed and the spring part 15 is deformed as shown in FIG. 6 and thereby the connection part 18 is displaced, the interference with the rotation stopping part 11 can be avoided.

In the clip 10 according to the first embodiment, the connection part 18 is closer to the rotation stopping part 11 than to the pressed part 16 in the y-direction and is located “between the pressed part 16 and the rotation stopping part 11”. On the other hand, in a modified example of the first embodiment, as shown by a double dashed line in FIG. 3, a connection part 18′ may be closer to the rotation stopping part 11 than to the pressed part 16 in the y-direction and is located “at a side opposite to the pressed part 16 with respect to the rotation stopping part 11”, namely the connection part 18′ may be located at a part passed through the rotation stopping part 11 from the pressed part 16. With this, the interference between the connection part 18′ and the rotation stopping part 11 can be precisely avoided without forming the escape part 13.

### Second Embodiment

A clip for a fuel injection valve according to a second embodiment is described with reference to FIG. 7A to FIG. 10.

In the embodiment described below, a part having a similar function to a part of the clip 10 according to the first embodiment is named the same name. The description of a basic configuration and a function of the part of the same name is omitted unless otherwise mentioned.

The clip 20 according to the second embodiment is, similar to the configuration of the first embodiment, formed by bending one wire member at a plurality of parts. In the first embodiment, the connection part 18 is “closer to the rotation stopping part 11” than to the pressed part 16 in the y-direction, while in the second embodiment, a connection part 28 is located at “a side opposite to a rotation stopping part 21” in the y-direction with respect to a pressed part 26. Further, a spring part 25 is arranged from the rotation stopping part 21 side in the y-direction with respect to the pressed part 26 to a side opposite to the rotation stopping part 21 in the y-direction with respect to the pressed part 26. Further, it is characterized in that only one rotation stopping part 21 is provided.

As shown in FIG. 7A to FIG. 9, in the wire member, a bending part 22, an inclined part 23, a contact part 24 at one side, a spring part 25 at one side, a pressed part 26 at one side, an extension part 27 at one side, and a connection part 28 at one side are connected in this order from one rotation stopping part 21. Further, through the connection part 28, the extension part 27 at an opposite side to the contact part 24 at the opposite side are connected in order opposite to the above-described order, and the contact part 24 at the opposite side is connected to an inclined end part 29.

In the second embodiment, “a side opposite to the rotation stopping part 21 in the y-direction” is described as “the connection part 28 side”. The wire member is extended along the downward direction (the minus z-direction) from the end part of the rotation stopping part 21, and the wire member is bent at the bending part 22 that is shifted by a predetermined distance Δh in the upward direction (the plus z-direction) with respect to the contact part 24 so as to be connected to the inclined part 23. The inclined part 23 is inclined in the downward direction to be far away from the virtual axial line J in the x-direction, and the inclined part 23 is connected to the contact part 24.

It is described again based on the contact part 24. The inclined part 23 is extended and inclined in the upward direction from the contact part 24 toward the rotation stopping part 21. The bending part 22 is formed at a position which is shifted by a predetermined distance Δh in the upward direction with respect to the contact part 24, and the inclined part 23 and the rotation stopping part 21 are connected at the bending part 22.

The contact part 24 is linearly extended in the y-direction from the rotation stopping part 21 toward the connection part 28. The spring part 25 draws an S-shape such that the spring part 25 rises in the upward direction from the end part of the contact part 24 on the connection part 28 side in the y-direction and returns to the rotation stopping part 21 side in the y-direction and then heads to the connection part 28 in the y-direction again, and thereby the spring part 25 reaches the pressed part 26 as the highest point. The extension part 27 is slightly inclined in the downward direction from the pressed part 26 and connected to the connection part 28.

In the fuel injection valve 60 shown in FIG. 10, the body part 61 to which the clip 20 is mounted is formed of resin integrally with the connector 69. A support groove 62 with which the rotation stopping part 21 of the clip 20 can fit is formed in the z-direction on an outer surface of the body part 61 at a side opposite to the connector 69.

When the fuel injection valve 60 to which the clip 20 is mounted is mounted to the connecting pipe 80, the rotation stopping part 21 supported by the support groove 62 is fitted with the rotation stopping fitting part 81, and thereby the support groove 62 is located right below the rotation stopping fitting part 81.

The clip 20 according to the second embodiment achieves the same effects of (1) to (3) of the first embodiment. Further, the following specific effects of (5) to (8) and (10) can be obtained.

(5) The connection part 28 is located at the side opposite to the rotation stopping part 21 in the y-direction with respect to the pressed part 26. With this, when the pressed part 26 is pressed, even if the spring part 25 is deformed and the connection part 28 is displaced in the y-direction, the connection part 28 can be prevented from interfering with the rotation stopping part 21.

(6) The spring part 25 is arranged from the rotation stopping part 21 side in the y-direction with respect to the pressed part 26 to the side opposite to the rotation stopping part 21. With this, the load received by the pressed part 26 is applied to a part near a center of the contact part 24, and therefore a position of the fuel injection valve 60 becomes stable.

(7) Since only one rotation stopping part 21 is provided, the width of the groove of the rotation stopping fitting part 81 of the connecting pipe 80 can be smaller. Further, if two rotation stopping parts are provided, a dimension of a width of the whole of the rotation stopping parts is changed due to variation in dimension of a gap between the two rotation stopping parts, while in a case where only one rotation stopping part 21 is provided, the dimension of the width of the rotation stopping part is determined by a diameter of the wire member, and this configuration facilitates management in dimension. Further, a cost of components and a cost in processing of the wire member can be reduced.

(8) As shown in FIG. 8, in the second embodiment, the bending part 22 is located at the position which is shifted by the predetermined distance Δh in the plus z-direction with respect to the contact part 24. Accordingly, a distance “Ls” between an end part 210 of the rotation stopping part 21 and the bending part 22 becomes shorter compared to a configuration in which a bending part 220 is located at the same height as the contact part 24 (Δh=0) as shown by a double dashed line. Here, if the rotation stopping part 21 is inclined around the bending part 22 as a fulcrum, displacement δx in the x-direction (see FIG. 8) of the end part 210 or displacement δy in the y-direction (see FIG. 9) of the end part 210 can be smaller as the distance “Ls” from the fulcrum is shorter.

Thus, in a case where the rotation stopping part 21 is fitted with the support groove 62 of the fuel injection valve 60 as shown in FIGS. 10A, 10B, it is preferable that a position of the bending part 22 is set such that the distance “Ls” from the end part 210 is to be shorter as much as possible in a range where the rotation stopping part 21 can fit with the support groove 62, in other words the distance Δh from the contact part 24 is to be longer as much as possible. With this, both of the effects of (8) and (10) described below can be achieved.

On the other hand, in a case where the effect of (8) is given priority against the effect of (10), the following modified example of the second embodiment may be adopted. In other words, as shown by a double dashed line in FIG. 8, a bending part 22′ is set such that a distance Δh′ from the contact part 24 is to be longer. In this case, interference between the bending part 22′ and the support groove 62 is avoided by shortening or omitting the support groove 62 of the fuel injection valve 60. With this, the displacement 210 of the end part 210 of the rotation stopping part 21 can be further smaller.

(10) In a case where the support groove 62 is formed on the body part 61 of the fuel injection valve 60 to which the clip 20 is mounted, a position of the clip 20 in a rotation direction with respect to the fuel injection valve 60 can be stable by fitting the rotation stopping part 21 with the support groove 62. Further, by fitting the rotation stopping part 21 with the rotation stopping fitting part 81 of the connecting pipe 80, the position of the fuel injection valve 60 in the rotation direction with respect to the connecting pipe 80 can be fixed via the clip 20.

Further, also in the first embodiment, the rotation stopping part 11 may be formed to be able to fit with the support groove 62.

### Third Embodiment

A clip for a fuel injection valve according to a third embodiment is described with reference to FIG. 11 to FIG. 13.

A clip 30 according to the third embodiment is also formed by bending one wire member at multiple points similar to the first and the second embodiments. Further, similar to the first and the second embodiments, a rotation stopping part 32 is formed on a contact part 34 at a side opposite to a spring part 35.

However, in the first and the second embodiments, the end part of the wire member configures the rotation stopping parts 11, 21, while in the third embodiment, the end part of the wire member configures an end part 37 arranged adjacent to a pressed part 36. In other words, in the first and the second embodiments, the connection parts 18, 28 that connect the two pressed parts 16, 26 are provided, however in the third embodiment, a rotation stopping connection part 31 that connects the two rotation stopping parts 32 is provided. This is the difference from the configurations of the first and the second embodiments.

As shown in FIG. 11 to FIG. 13, in the wire member, the pressed part 36, the spring part 35, a contact part 34, an intermediate part 33, the rotation stopping part 32 are connected in order from the end part 37 at one side, and through the rotation stopping connection part 31, the rotation stopping part 32 at an opposite side to the end part 37 at the opposite side are connected in order opposite to the above-described order.

Specifically, the wire member is inclined in the upward direction (the plus z-direction) from the end part 37 located between the rotation stopping part 32 and the pressed part 36 in the y-direction toward the pressed part 36. The spring part 35 is inclined in the downward direction (the minus z-direction) from the pressed part 36 toward a side opposite to the rotation stopping part 32 and after the spring part 35 is further extended in the downward direction, the spring part 35 is bent substantially perpendicularly and connected to the contact part 34. The contact part 34 is linearly extended in the y-direction.

The intermediate part 33 is bend substantially perpendicular at an end of the contact part 34 and extended in the upward direction, and then the intermediate part 33 is inclined to be close to the virtual axial line J in the x-direction and connected to the rotation stopping part 32.

The two rotation stopping parts 32 are formed respectively at sides of the two contact part 34 opposite to the spring parts 35. The rotation stopping connection part 31 connects end parts of the rotation stopping parts 32 with each other. In a configuration exemplary shown in FIG. 11 to FIG. 13, the two rotation stopping parts 32 are arranged substantially parallel to each other, and the rotation stopping connection part 31 is formed in an U-shape so as to connect upper ends of the two rotation stopping parts 32.

The clip 30 according to the third embodiment achieves the same effects of (1) and (2) of the first and the second embodiments. Further, the following specific effect of (9) can be obtained.

(9) The rotation stopping connection part 31 of the clip 30 connects the two rotation stopping parts 32 with each other in a shorter distance compared to the connection parts 18, 28 of the first and the second embodiments. Accordingly, the whole length of the wire member can be shortened, and therefore a cost of components can be reduced.

Further, by forming the support groove 62 of the body part 61 of the fuel injection valve 60 to have a width with which the rotation stopping connection part 31 of the clip 30 is just fitted against a width of substantially one wire member as shown in FIGS. 10A and 10B, the effect of (10) described above can be obtained in the third embodiment.

### Other Embodiments

(A) Basically, in the clip for a fuel injection valve according to the first to the third embodiments, a pair of the contact parts, the spring parts, the pressed parts and the like, namely each two of them are arranged symmetrically at the both sides in the x-direction with respect to the virtual axial line J except only one rotation stopping part provided in the second embodiment. However, the contact parts, the spring parts, the pressed parts and the like may be arranged asymmetrically at one side and the other side in the x-direction with respect to the virtual axial line J. Alternatively, the contact part, the spring parts, the pressed part and the like may be arranged only at one side in the x-direction with respect to the virtual axial line J. In such a case, the connection part may not be provided. In a configuration in which the contact part, the spring part, the pressed part and the like are arranged only at one side, the fuel injection valve 60 can be held as long as the clip has predetermined strength.

(B) In the embodiments, the contact parts 14, 24, 34 continuously formed in the y-direction are counted as “one contact part” at one side in the x-direction, and “two contact parts” at both sides in the x-direction. Here, for example, in a case where a protrusion which protrudes in the plus z-direction is formed in the middle of the contact part and a part which contacts with the contacted surface 64 is divided into a plurality of parts, the contact part including the divided parts can be deemed as “one contact part” because the parts achieve a function to contact with the contacted surface 64 at one side in the x-direction by cooperating with each other.

Similarly, another part, which is not continuously formed, may be similarly deemed as “one part” as long as a plurality of parts can achieve one function by cooperating with each other.

(C) The connection parts 18, 28 in the first and the second embodiments connect the two pressed parts 16, 26 in the x-direction via the extension parts 17, 27, respectively. As another configuration, the connection part may connect the two pressed parts directly without providing the extension part.

However, when the pressed part is considered as a strict point, it is considered that “extension part in wider sense”, for example including a part having a length less than the diameter of the wire member, always exists. On the other hand, in a case where the extension part is deemed as “a part having a length more than several times of the diameter of the wire member and apparently visible that it is extended from the pressed part”, such an “extension part in narrower sense” may not be formed.

(D) A configuration of the fuel injection valve to which the clip for a fuel injection valve according to the present disclosure is mounted, or a configuration of the fuel supply pipe, the internal combustion engine or the like to which the fuel injection valve is mounted is not limited to an example shown in FIG. 4, FIG. 5 and the like of the aforementioned embodiments.

The present disclosure has been described based on the embodiments, however the present disclosure is not limited to the embodiments or the structures. The present disclosure includes various modified examples or modifications in the equivalent range. In addition, while the various combinations and configurations, other combinations and configurations, including more, less or only a single element, are also within the scope of the present disclosure.

1. A clip for a fuel injection valve used in a fuel injection device including a fuel supply pipe, and a fuel injection valve that is connected to the fuel supply pipe and is capable of injecting fuel supplied from the fuel supply pipe into an internal combustion engine from an injection hole at a distal end of the fuel injection valve, the clip for a fuel injection valve being fitted with a rotation stopping fitting part formed on the fuel supply pipe and mounted on at least a part of an outer peripheral of the fuel injection valve, the clip for a fuel injection valve holding the fuel injection valve between the fuel supply pipe and the internal combustion engine, the clip for a fuel injection valve being formed by one wire member bent at multiple points,
in a case where an axis of the fuel injection valve is defined as a virtual axial line, a direction parallel to the virtual axial line is defined as a z-direction, a direction toward the fuel supply pipe in the z-direction is defined as a plus z-direction, a direction toward the distal end of the fuel injection valve in the z-direction is defined as a minus z-direction, a direction orthogonal to the z-direction and connecting the virtual axial line and a side where the rotation stopping fitting part is formed is defined as a y-direction, and a direction orthogonal to both of the z-direction and the y-direction is defined as an x-direction,
the clip for a fuel injection valve comprising:
at least one contact part that contacts with a contacted surface formed on the fuel injection valve;
at least one pressed part located at a side of the plus z-direction with respect to the contact part and pressed in the minus z-direction by a pressing surface formed on the fuel supply pipe;
at least one spring part formed between one end of the contact part in the y-direction and the pressed part, the spring part being elastically deformed by a load in the minus z-direction received by the pressed part and transmitting the load in the minus z-direction to the contact part; and
at least one rotation stopping part extended in the plus z-direction from an end part of the contact part at a side opposite to the spring part and fitted with the rotation stopping fitting part.

2. The clip for a fuel injection valve according to claim 1, wherein
the two contact parts are individually formed at one side and at the other side in the x-direction with respect to the virtual axial line.

3. The clip for a fuel injection valve according to claim 1, wherein
the two pressed parts are individually formed at one side and at the other side in the x-direction with respect to the virtual axial line, and
the clip for a fuel injection valve further comprises a connection part that connects the two pressed parts in the x-direction.

4. The clip for a fuel injection valve according to claim 3, wherein
the connection part is located at a side of the rotation stopping part in the y-direction with respect to the pressed part, and
an escape part that avoids interference between the connection part and the rotation stopping part in a range of deformation of the connection part is formed between the contact part and the rotation stopping part.

5. The clip for a fuel injection valve according to claim 3, wherein
the connection part is located at a side opposite to the rotation stopping part in the y-direction with respect to the pressed part.

6. The clip for a fuel injection valve according to claim 5, wherein
the spring part is arranged from a side of the rotation stopping part in the y-direction with respect to the pressed part to a side opposite to the rotation stopping part in the y-direction with respect to the pressed part.

7. The clip for a fuel injection valve according to claim 3, wherein
a number of the rotation stopping part is one.

8. The clip for a fuel injection valve according to claim 3, further comprising:
an inclined part extended from the contact part toward the rotation stopping part while inclining in the plus z-direction; and
a bending part formed at a position shifted by a predetermined distance in the plus z-direction from the contact part, and connected to the inclined part and the rotation stopping part.

9. The clip for a fuel injection valve according to claim 2, wherein
the two rotation stopping parts are respectively formed on the two contact parts at a side opposite to the spring part, and
the clip for a fuel injection valve further comprises a rotation stopping connection part that connects end parts of the two rotation stopping parts with each other.

10. A fuel injection valve unit comprising:
the clip for a fuel injection valve according to claim 1; and
the fuel injection valve to which the clip for a fuel injection valve is mounted, wherein
the fuel injection valve has a support groove on an outer surface of the fuel injection valve on a side where the rotation stopping part of the clip for a fuel injection is located, the support groove receiving the rotation stopping part.
